(19) United States
(12) Patent Application Publication
(10) Pub. No.: US 2025/0265359 A1
(43) Pub. Date: Aug. 21, 2025

(54) CONFIGURATION BASED DATASET GENERATION FOR CONTENT SERVING SYSTEMS

(71) Applicant: Google LLC, Mountain View, CA (US)

(72) Inventors: Kumar Rishabh, Redmond, WA (US); Wei Huang, Kirkland, WA (US); Zhenyu Liu, San Jose, CA (US)

(21) Appl. No.: 18/858,531

(22) PCT Filed: Jan. 11, 2023
(86) PCT No.: PCT/US2023/010585

§ 371 Date: Oct. 21, 2024

(51) Int. Cl. G06F 21/62; H04L 9/08

(52) U.S. Cl. CPC G06F 21/6209; H04L 9/0816

(57) ABSTRACT

The present disclosure provides methods, systems, and media for a computing device that provide a configuration-driven pipeline enabling coalescing numerous data sources to curate customized datasets that can be used in training and/or inference operations relating to content machine learning models deployed for identifying digital components to provide to client devices. In one aspect, the methods include receiving a request for generation of training data for training a contextual model used to identify digital components; identifying, using configuration files and the received request, a key and corresponding value type for extraction from the data; extracting, from the data corresponding to the plurality of client profiles, data for the identified key and value type; aggregating the data for the identified key and value type, to obtain an aggregated dataset; determining that the aggregated dataset satisfies a set of validation criteria; and in response, providing the aggregated dataset as training data.

### BACKGROUND

When a client/user device navigates to a web site using an application (e.g., a web browser), one or more digital components can be provided by a content server or content platform for display within the web page provided on the client device. In some instances, the digital components are identified for provision by one or more content identification servers, each of which may have a models that ingest a certain sets of inputs, based on which they generate outputs identifying the one or more digital components to be provided on the web page provided within the application. These models (e.g., machine learning models) can be trained using training data aggregated from various browsing sessions and various signals obtained during such browsing sessions.

As used throughout this document, the phrase “digital component” refers to a discrete unit of digital content or digital information (e.g., a video clip, audio clip, multimedia clip, image, text, or another unit of content). A digital component can electronically be stored in a physical memory device as a single file or in a collection of files, and digital components can take the form of video files, audio files, multimedia files, image files, or text files. For example, the digital component may be content that is intended to supplement content of a video or other resource. More specifically, the digital component may include digital content that correlates to resource content (e.g., the digital component may relate to a topic that is the same as or otherwise related to the topic/content on a video). The provision of digital components can thus supplement, and generally enhance, the web page or application content.

### SUMMARY

This specification relates to relates to a configuration-driven pipeline that enables coalescing numerous data sources to curate customized datasets that can be used in training and/or inference operations relating to machine learning models (e.g., contextual signal drivel models that use contextual data received from a client device to identify digital components to provide to the client device).

In general, one innovative aspect of the subject matter described in this specification can be embodied in methods including the operations of receiving a request for generation of training data using data corresponding to a plurality of client profiles corresponding to a content platform, the training data for training a contextual model that used to identify digital components to provide to a client device; identifying, using a set of configuration files and based on the received request, a key and corresponding value type for extraction from the data corresponding to multiple client profiles; extracting, for each client profile and from the data corresponding to the multiple client profiles, data for the identified key and corresponding data for the identified value type; aggregating the data for the identified key and the corresponding data for the identified value type, to obtain an aggregated dataset including the key and an aggregated value type obtained by aggregating the data for the identified value type for the multiple client profiles; determining that the aggregated dataset satisfies a set of validation criteria; and in response to determining that the aggregated dataset satisfies the set of validation criteria, providing the aggregated dataset as the training data to a training pipeline for training the contextual model.

Other embodiments of this aspect include corresponding methods, apparatus, and computer programs, configured to perform the actions of the methods, encoded on computer storage devices. These and other embodiments can each optionally include one or more of the following features.

In some implementations, the aggregating to obtain the aggregated dataset includes determining that a data privacy policy is satisfied.

In some implementations, the data privacy policy specifies a maximum number of data points for a particular value type corresponding to a particular key; and determining that the data privacy policy is satisfied includes determining that the number of the data points for the identified value type satisfies the maximum number of data points.

In some implementations, the data privacy policy specifies that the aggregated dataset contains data from a minimum number of client profiles; and determining that the data privacy policy is satisfied comprises determining that that the aggregated dataset contains more than the minimum number of client profiles.

In some implementations, determining that the aggregated dataset satisfies the set of validation criteria for training data includes determining, for the identified key, that a distribution of data of the aggregated value satisfies a pre-determined data distribution for the identified type.

In some implementations, the method further includes obtaining additional aggregated data for another value type corresponding to the identified key; and combining the additional aggregated data for another value type with the training data that is provided to the training pipeline.

In some implementations, aggregating the data for the identified value type includes performing a summation, average, or histogram-based operation with respect to the data for the identified value type.

Particular embodiments of the subject matter described in this specification can be implemented so as to realize one or more of the following advantages. The techniques described in this specification utilize a robust, configuration driven pipeline (also referred to herein as config-driven pipeline) that can facilitate coalescing of data from various different data sources to generate aggregated datasets, which then can be leveraged for the training, deployment, or inference operations of models (e.g., contextual feature-driven models) that facilitate identification of digital components based on received signals (e.g., contextual features received from a client device). Such config-driven pipelines facilitates generation of customizable and curated datasets that can be used for training and inference operations of the relevant models that preserve data security (e.g., by performing aggregations and privacy preserving operations) to curate a dataset but without comprising security and privacy of the data as it relates to client devices from which such data is obtained. Moreover, curation and collection of such data using the config-driven pipeline described herein achieves the benefit of training models (e.g., the contextual signal-driven model) with robust data that in turn improves the accuracy of underlying models (e.g., that utilize contextual signals to identify digital components to provide to client devices for display during their respective browsing sessions).

Additionally, this increased accuracy results in more resource efficient digital component identification by removing processing burden from downstream content serving algorithms. For example, an accurate contextual model can narrow the “pool” of digital components each downstream content serving algorithm evaluates for selection. These downstream algorithms would otherwise each have to independently predict the digital components to serve to a client from a much larger available digital component “pool.” The use of a standardized audience interest profile centralizes the process of predicting digital components to serve, such that the number of digital components that need to be evaluated by independent content serving algorithms is substantially reduced.

Additionally, the techniques described in this specification can offer increased privacy protection for consumers. Traditional solutions to generating training data involved preserving collected data relating to the specific browsing session of the client for input into the algorithm. The methods and techniques described herein enable development of training data based on anonymized client browsing sessions—all without collecting data unique to the individual user. The techniques described in this specification negate the need for “cookies” or similar methods of data collection. Instead, this technique incorporates features of the browsing session that cannot be used to identify an individual user. This improvement in network data security has many advantages, to include increased consumer confidence, increased privacy protection, higher engagement, and regulatory compliance. Additionally, certain content serving algorithms require training data that meets the above data security requirements and the techniques described herein facilitate generation of such data security-compliant training data.

The details of one or more implementations are set forth in the accompanying drawings and the description, below. Other potential features and advantages of the disclosure will be apparent from the description and drawings, and from the claims.

### BRIEF DESCRIPTION OF THE DRAWINGS

FIG. 1 is an overview of an example system implementation.

FIG. 2 is a detailed view of an example training data generation pipeline.

FIG. 3 is an example process where training data are developed.

FIG. 4 is a block diagram of an example computer system that can be used to perform operations described.

### DETAILED DESCRIPTION

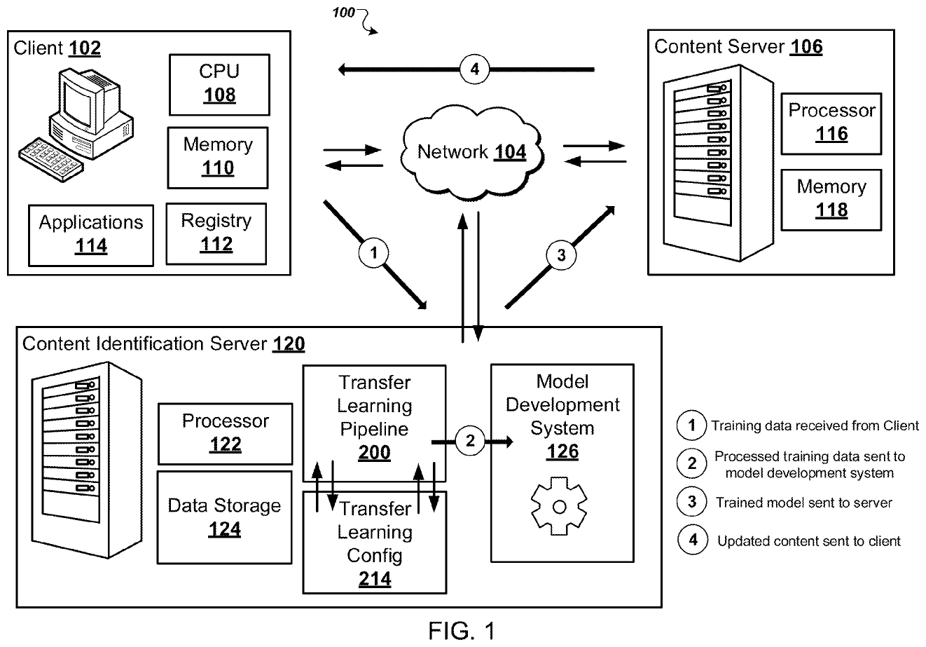

As summarized below, and described in greater detail with reference to FIGS. 1-4, this specification relates to a configuration-driven pipeline that enables coalescing numerous data sources to curate customized datasets that can be used in training and/or inference operations relating to machine learning models (e.g., contextual signal drivel models that use contextual data received from a client device to identify digital components to provide to the client device).

As used in this specification, “context” or “contextual” refers to the characteristics of a client browsing session. “Context” or “contextual data” does not refer to user information or personal data, nor is context used to specifically identify an individual user or develop a profile unique to that individual user. Some examples of context or contextual data can include the URL or web page accessed by the client device during a particular browsing session, a type of browser used to access the content, location of the client device, time at which the device, or any estimated or actual demographics provided by the user of the client device.

In some implementations, data from multiple data sources is extracted to generate features and labels, where such data relates to data obtained from numerous prior browsing sessions relating to numerous client devices. The features and labels are then aggregated, correlated, validated, and provided to one or more downstream pipeline, e.g., a contextual signal-based machine learning model (that can use this data for training, deployment, or inference operations). As used in this specification, a “label” or “key” represents contextual elements of a digital component, client, browsing session, or a combination of the three. A label can be, for example, a URL, URL description, browser, or content genre, to name just a few options. Because labels can be designated preemptively, these options are representative examples and more solutions are possible. It should be noted that the use of a “label” as used in this application differs from its traditional use in machine learning. As used in this specification, a “feature” or “value type” represents a characteristic indicative of a label. A feature can be, for example, a URL description, gender or age demographic, digital component ID, digital component channel, or time, to name just a few options. Because features can be designated preemptively, these options are representative examples and more solutions are possible. It should be noted that the use of a “feature” as used in this application differs from its traditional use in machine learning.

In some implementations, labels and features are extracted from the browsing parameters, e.g., in response to a request for data (e.g., training data for use in downstream pipelines such as downstream contextual models). In some implementations, the request may also include instructions to extract particular labels and features. As an example, a label designated for extraction can be a URL associated with a digital component. In this example, the corresponding feature that is extracted can be the user demographic of the client that accessed the URL. Other examples of labels can include a URL, URL description, browser, content genre, affinity designation, in-market designation, or user demographic. Other examples of features can include a URL description, gender or age demographic, client country, client geographic region, client browser type, digital component ID, digital component channel, number of channel views, number of channel subscribers, number of channel subscribers per unit of time, time the digital component was accessed, digital component product type, digital component duration, a number of views, or a number of “likes” or “dislikes.” It should be noted that labels and features are not mutually exclusive, and one “feature” could be a “label” in a different set of instructions.

After extraction, the labels and features can then be aggregated. In some implementations, this aggregation process is used to determine correlations between a label and feature that may become apparent across the browsing parameters of many clients. In some implementations, these correlations can be referred to as a “mapping.” Label-feature mappings can be used to predict the browsing preferences of a future client that may show similarities to the clients used to generate the mapping. As an example, a label can be extracted for a specific URL with the corresponding feature being the user demographic of the client that accessed the URL. In this example, the label-feature mapping can be the historical user demographic associated with the URL (e.g., 60% Male, 40% Female). Other examples of label-feature mappings can be mapping a particularly high number of client views of a label, or a high number of client views when compared to other labels. In some implementations, instructions for generation the label-feature mapping are included in the aggregation instructions.

In some implementations, privacy policies ensure that a particular client's browsing parameters cannot be determined. In some implementations, this privacy policy is implemented as part of the aggregation process to ensure that the correlation between labels and features could not be used to identify a particular client from among the many clients used for training data generation. In some implementations, the privacy policy specifies certain conditions that must be met in order for a set of aggregated data to be accepted. For example, the privacy policy can specify that a set of training data must contain a certain minimum number of clients in its browsing parameters, such that the preferences of an individual client could not be identified.

In some implementations, after correlation (and/or applying the privacy policy-based processing), the training data is qualified during a validation process. In some implementations, the validation process (and the associated determination of whether the training data is qualified) is performed to ensure that the system does not propose training data that is substantially different than the “ground truth,” or solutions that diverge significantly from the expected range of values. As used in this specification, “qualified” refers to the evaluation and acceptance of training data to meet a certain level of quality. For example, a qualified set of training data can be proven to be within a certain margin obtained from other sources, for example, census data. While certain examples of quality measurement are presented in this specification, these examples should not be considered to be limiting to either the data sample or the use of the sample. A “qualified” data sample is one that has been verified to meet a certain level of effectiveness for its intended use—whatever that may be.

The following disclosure provides additional details of the implementation and operation of the config-driven transfer learning framework where training data is generated and qualified based on the browsing parameters of multiple client devices.

Further to the descriptions throughout this document, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

FIG. 1 is an overview of an example system implementation 100. The system 100 includes a plurality of clients 102, one or more networks 104, a plurality of content servers 106, and one or more content identification servers 120. The network 104 can include a local area network (LAN), a wide area network (WAN), the Internet, or a combination thereof. The network 104 can also include any type of wired and/or wireless network, satellite networks, cable networks, Wi-Fi networks, mobile communications networks (e.g., 3G, 4G, and so forth), or any combination thereof. The network 104 can utilize communications protocols, including packet-based and/or datagram-based protocols such as internet protocol (IP), transmission control protocol (TCP), user datagram protocol (UDP), or other types of protocols. The network 104 can further include a number of devices that facilitate network communications and/or form a hardware basis for the networks, such as switches, routers, gateways, access points, firewalls, base stations, repeaters or a combination thereof. The network 104 connects client devices 102, content servers 106, and content identifications servers 120.

In some implementations, client device 102 is a personal computing device. Examples of such a personal computing device include personal computers, smartphones, PDAs, and other devices that are able to access and view content over an external network. In some implementations, client 102 includes a central processing unit (CPU) 108, a memory 110, a registry 112, and one or more applications 114. In some implementations, applications 114 can include web browsing applications that allow the client device 102 to view content over an external network 104, for example, the Internet.

In some implementations, Internet content is stored on a plurality of content servers 106 in communication with the network 104. In some implementations, content server 106 includes one or more processors 116 and a memory device 118. In some implementations, websites visited by the client device 102 store their content in the memory 118 of the plurality of content servers 106. In some implementations, processors 116 within content servers 106 can decide which content to present to the client device 102. This content can be presented to the client device 102 through the client's web browsing applications 114. In some implementations, the content stored on content servers 106 can be assigned identifiers (IDs), for example, features or labels that describe aspects of the content.

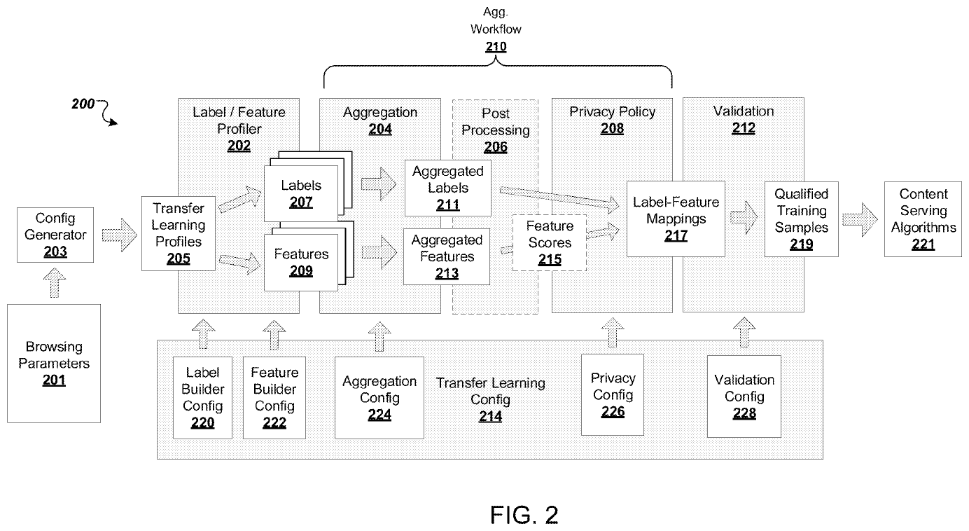

In some implementations, the system 100 can include one or more content identification servers 120 in communication with the network 104. In some implementations, content identification server 120 is used to refine the process in which content servers 106 provide content (e.g., digital components) to the client device 102, e.g., by identifying the digital components or the types of digital components to be provided to one or more client devices 102 in response to content requests from the client device(s) 102. In some implementations, content identification server 120 includes one or more processors 122, data storage 124, a model development system 126, a transfer learning pipeline 200, and a transfer learning config 214 (as further described with reference to FIG. 2). In some implementations, model development system 126 can use the context of the relationship between the client device 102 and content servers 106 to adjust the operation of the processors 116 in the content servers 106 using a machine learning algorithm.

In some implementations, the transfer learning pipeline 200 receives browsing data from the client devices 102 over network 104. As used in this specification, “transfer learning” refers to the process of using client preference or historic browsing and interaction data available for one set of client devices, to curate datasets that can be used to train models for inferring digital components to identify for another set of client devices, for which such data is otherwise unavailable, and for which, e.g., only contextual features or signals are available and provided as input for the model.

In some implementations, the transfer learning pipeline 200 parses this browsing data to generate qualified training samples that can be used train a machine learning algorithm within the model development system 126, which, e.g., can subsequently be deployed to identify/recommend types of digital components to provide to the client device based on input, contextual data received by the client device. By facilitating an improvement in the quality of the training data used by the model development system 126, the transfer learning pipeline 200 can improve the effectiveness of the content identification server 120 and the accuracy of its content recommendations to downstream content servers 106 which use these recommendations to serve content to clients 102.

In some implementations, the performance of the transfer learning pipeline 200 can be determined by the instructions loaded into the transfer learning config 214 by a client device 102 or content server 106 operating on network 104. These instructions can specify, for example, certain labels or features to extract, how extracted information should be arranged or organized, and how information should be anonymized to maintain privacy. In some implementations, the transfer learning config 214 includes multiple separate configs that each control their associated step in the transfer learning pipeline 200. In some implementations, the instructions loaded within the configs of the transfer learning config 214 can be altered to achieve different operating parameters of the transfer learning pipeline 200. Specific examples of these instructions will be provided in the description of FIG. 2.

FIG. 2 is a detailed view of an example training data generation pipeline 200. In some implementations, the transfer learning pipeline 200 includes a number of processing steps that can be executed by suitable hardware (e.g., one or more processors or servers) within content identification server 120. In some implementations, these steps include a config generator 203, a label and feature profilers 202, an aggregation workflow 210, and a validation stage 212. In some implementations, the aggregation workflow 210 can be further divided into a plurality of sub-processes. In some implementations, these subprocesses include an aggregation process 204, a post-processing stage 206, and a privacy policy stage 208. In some implementations, each of these processes and subprocesses are controlled by an associated config located in the transfer learning config 214. In some implementations, the instructions of the transfer learning config 214, including the number and relation of constituent configs, can be provided by an operator of the content server 106 over network 104.

The config generator 203 receives input from clients 102 in the form of various browsing parameters 201. In some implementations, the config generator 203 can request this information from the clients 102 or content servers 106 in response to receiving a request for training data. In some implementations, the request received by the config generator 203 can also include instructions for the transfer learning config 214. Browsing parameters 201 can include an application history, browsing history, location history, affinity, in-market designation, user impression, or transaction history, among other things. In some implementations, the config generator 203 then processes these browsing parameters 201 and extracts a plurality of transfer learning profiles 205, each of which corresponds to the selected browsing parameters 201 of a client. A transfer learning profile can also be referred to as a “client profile.” These browsing parameters 201 can correspond to a single browsing session, or multiple browsing sessions separated by a period of time. In some implementations, information in the transfer learning profile 205 can also be inferred from the browsing parameters, for example, an approximated user age or gender. In other implementations, this information can be obtained directly by asking the user during an application profile creation process.

The plurality of transfer learning profiles 205 are then parsed by label and feature profilers 202 that extract labels 207 and features 209 from the transfer learning profiles 205. In some implementations, the parsing of the label and feature profilers 202 is directed, respectively, by the label builder 220 and feature builder 222 configs, which include pre-defined instructions on the types of labels 207 and features 209 that should be extracted from the transfer learning profiles 205. In some implementations, the instructions of the label 220 and feature 222 builder configs can be included in the initial request for training data provided to the config generator 203. This allows the request for training data to also specify what particular labels 207 and features 209 should be extracted.

For example, if the transfer learning profiles 205 include a browsing history, the label and feature profiler 202 can be instructed by the configs to extract a series of URL hyperlinks as labels 207, and a series of URL characteristics as features 209. In this example, an example URL label 207 can be “www.cnn.com”, while an example feature 209 can be “news.” Another example of an extracted feature 209 can be the gender of the users that visited the site (Male or Female). Other examples to which labels 207 can be assigned include timestamps, locations, video IDs, a search history, inferred tokens, taxonomy results, and other identifying characteristics of a digital component. Other examples of features 209 can include a content category, time, genre, affinity, or age, among other things.

It should be understood that because the performance of the label and feature profilers 202 is directed by the instructions in configs 220 and 222, the system 200 is able to extract any specified labels 207 and features 209 to which extraction instructions can be created. As such, there will be many possibilities as to the labels 207 and features 209 that are capable of being extracted using this method.

The extracted labels 207 and features 209 are then aggregated in the aggregation workflow 210. In some implementations, the aggregation workflow 210 can include an aggregation process 204 where labels 207 and features 209 are combined or organized according to the instructions of the aggregation config 224. In some implementations, these instructions can include a direction to group a certain number of labels 207 or features 209, arrange the contents of labels 207 or features 209 into a histogram, or to average a particular result among the labels 207 or features 209. For example, for a demographic feature 209 the aggregation process can parse instructions specifying a particular demographic distribution and, pursuant to those instructions, combine the gender of all of the individual features 209 into a demographic distribution, such as, e.g., 60% Male, 40% Female. In another example, the aggregation process can parse instructions specifying a window of time and, pursuant to those instructions, create a time distribution corresponding to when a URL label 207 was accessed. In this example, the time distribution would be presented as an aggregated feature 213. In a further example still, the aggregation process can parse instructions specifying a geographic region of interest and, pursuant to those instructions, aggregate the geographic region feature 209 of the clients that accessed a content channel label 207. In this example, the aggregated geographic regions can be presented as a histogram or chart aggregated label 211. In some implementations, the aggregated features 213 are then each mapped to an aggregated label 211 using a trend in the aggregated data or an established historical correlation. In some implementations, a label or feature can aggregate features as a combination, e.g., as combination of URL (e.g., xyz.com) and features for different regions (e.g., UK and US), such as xyz.com_US and xyz.com_UK.

In some implementations, the aggregated labels 207 and features 209 can be further enhanced during the aggregation process 204 as directed by the aggregation config 224. For example, if the initial aggregation instructions are to aggregate a client “gender demographic” feature 209 207 for a “URL” label 207, the aggregation can be further enhanced by also aggregating a “time accessed” feature 209 for each of the “gender demographic” features 209. In this example, the data can be presented as a “time accessed” histogram with entries in each histogram bar indicating the gender demographic at that point in time. In some implementations, this enhancement can be part of the original instructions of the aggregation config 224 to occur during aggregation. In this way, the aggregation instructions of the aggregation config 224 can specify a series of aggregations to be performed. In some implementations, this “series” of aggregations can be layered, such that the initial aggregation is “enhanced” with additional data. In other implementations, enhancement can be performed in response to certain data trends observed by the aggregation config 224 after aggregation. Enhancement of training data can be performed such that the provided data is more robust and more accurately reflects complexities that may be present in the browsing data.

In some implementations, an optional post-processing step 206 is conducted in the aggregation workflow 210 as directed by the aggregation config 224. This post processing step 206 assigns scoring values 215 to the aggregated features 213 based on a mathematical function. In some implementations, the mathematical function includes the probability the feature 213 corresponds to the associated label 211. In some implementations, these probabilities can be determined from previous historical data. For example, if previous training data sets had identified that a certain access time corresponds to a URL for one geographic region, the label-feature mapping can reflect a higher probability for this access time when the same URL is examined for a different geographic region. In other implementations, the probabilities can be determined by a term frequency-inverse document frequency (TF-IDF) measure. In some implementations, the TF-IDF measure is implemented by the post-processing step 206 such that the frequency of the feature 209 in the set of aggregated features 213 is measured along with the appearance of the feature 209 across a set of labels 207. These feature scores 215 can then be compared in the later validation process 212 to specified quality metrics for the label-feature mappings 217.

The aggregation workflow 210 also includes a privacy policy stage 208. In some implementations, the processing of this privacy policy stage 208 is directed by the privacy config 226, which includes instructions for abstracting the aggregated labels 211 and features 213 such that the individual client profile (in the form of an individual transfer learning profile 205) cannot be identified. In some implementations, the privacy config 226 can include instructions specifying a minimum number of transfer learning profiles 205 per aggregated label 211, or a minimum number of unique transfer learning profiles 205 that must be present in a set of data (i.e. a minimum number of clients), or a maximum number of unique labels 207 to be mapped to a feature 209 in a set of data (such that a unique transfer learning profile 205 could be identified).

The output of the privacy policy component 208, and the aggregation workflow 210, is a plurality of label-feature mappings 217. These mappings 217 describe the relation of a feature 211 to a label 213. For example, a URL can be correlated to a specific demographic. Or, a particular time can be associated with a URL or location. In some implementations, label-feature mappings can be determined through a correlation between an aggregated label 211 and feature 213 observed during aggregation. For example, if it is determined after the aggregation process 204 that the aggregated “access time” feature 213 shows a particular time that an aggregated “URL” label 211 is accessed, a label-feature mapping 217 can be established that shows that a client accessing the URL correlates to a specific time. In another example, if it is determined after the aggregation process 204 that a specific gender demographic exists for a content channel label 211, in the form of an aggregated feature 213, a label-feature mapping 217 can be established that associates that gender demographic with the content channel. In these examples, the requirement for correlation can be specified within the instructions of the aggregation config 224. These instructions can be, for example, to create a label-feature mapping for the most prevalent feature 209 within the aggregated features 213. In other implementations, the instructions in the aggregation config 224 can specify to create label-feature mappings 217 based on the results of past training data generation.

The label-feature mappings 217 are then provided to the validation stage 212. In some implementations, the performance of the validation stage 212 is directed by the validation config 228, which provides instructions for quality metrics that should be satisfied to qualify the mapping. These metrics can include, e.g., a minimum feature correlation probability, as established by the feature scores 215, or a maximum allowable deviation from an expected value. For example, if it is known that the demographic of a certain geographic area is 60% female and 40% male, and a label-feature mapping 217 associated with the area shows a demographic distribution of 30% female and 70% male, this label-feature mapping 217 may fail to meet the quality requirements specified in the validation stage 212 because the result is different than the ground-truth (i.e., the 60-40 distribution). As another example, if the label-feature mapping 217 was 55% female and 45% male, this may satisfy the quality requirements specified in the validation stage 212 because the result may be within a threshold amount (e.g., as specified in the config, which in this example could be less than or equal to +/−5% from the established distribution) to the ground-truth. As another example, if the feature correlation probability of a data set is measured at 0.70, the data set can fail to meet the quality requirement of a minimum feature correlation probability of 0.85.

Once label-feature mappings 217 have passed through the validation stage 212, they are considered qualified training samples 219 that can be provided as training data to downstream algorithms. In some implementations, these downstream algorithms can be operating within the model development system 126 operating within the content identification server 120. In other implementations, these algorithms can be operating on other components over network 104, for example, content servers 106. In some implementations, as opposed to being provided as training data, validated label-feature mappings 217 can also be used in the generation of further label-feature mappings 217. For example, if a correlation in one label-feature mapping 217 is determined, this correlation can be incorporated into the instructions of the transfer learning config 214 such that subsequent label-feature mappings 217 can be generated. In some implementations, previously identified features 209 could become labels 207 in a new label-feature mapping 217, and vice-versa. For example, once a label-feature mapping 217 is executed for a URL label 207 and a demographic feature 209, another label-feature mapping 217 can be created afterwards where the demographic is now a label 207 and the feature is now an “in-market” designation feature 209.

Examples of these downstream algorithms can include content serving algorithms 221 used to predict a client's preference for certain digital components. In some implementations, content serving algorithms can be located within the model development system 126 of a content identification server 120. However, because the methods described in this specification operate in a distributed computing environment, it should be understood that the algorithms 221 that receive training data from the transfer learning pipeline 200 can be located in other hardware in communication with the transfer learning pipeline 200 over network 104, for example, a separate model development server or content server 106.

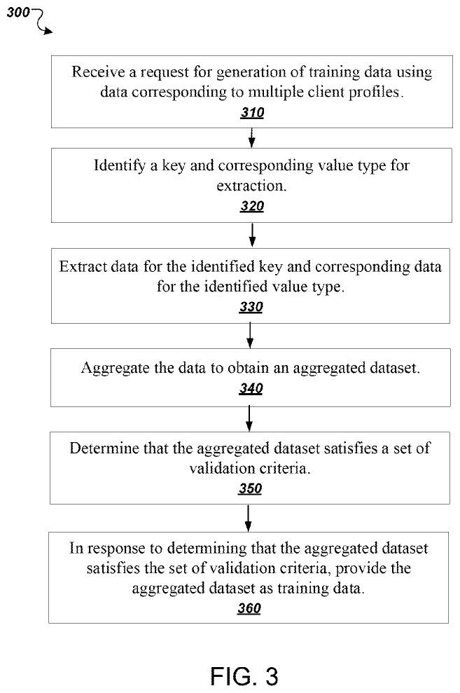

FIG. 3 is an example process 300 where qualified training data are developed. Operations of the process 300 are illustratively executed by a system, e.g., a system as shown in FIGS. 1 and 2. Operations of the process 300 can also be implemented as instructions stored on one or more computer readable media, which may be non-transitory, and execution of the instructions by one or more data processing apparatus can cause the one or more data processing apparatus to perform the operations of the process 300. As used below, a “key” corresponds to the “labels” of the above descriptions, while “value types” correspond to “features.”

In some implementations, the process 300 includes receiving a request for generation of training data using data corresponding to multiple client profiles 310 (as described with reference to FIGS. 1-2). In some implementations, the client profiles include browsing parameters that correspond to viewed digital components. In some implementations, this training data can be provided to train a contextual model used to identify digital components to provide to a client device.

In some implementations, the process 300 includes identifying a key and corresponding value type for extraction 320 (as described with reference to FIGS. 1-2). In some implementations, the key and value type are specified to correspond to certain characteristics of the browsing parameters. In some implementations, the process to identify a key and corresponding value type can be specified in a configuration file. In some implementations, this configuration file can be provided over a network by an external device.

In some implementations, the process 300 includes extracting data for the identified key and corresponding data for the identified value type 330 (as described with reference to FIGS. 1-2). In some implementations, the extraction of data can be specified by configuration file. In some implementations, these instructions can specify how to perform the extraction, and how data should be organized following the extraction. In some implementations, this organization can include instructions that specify a list or graph that should be formed with the extracted data.

In some implementations, the process 300 includes aggregating the data to obtain an aggregated dataset 340 (as described with reference to FIGS. 1-2). In some implementations, the format of the aggregation can be specified by a configuration file. In some implementations, the aggregated data set includes an aggregated key and an aggregated value type. In some implementations, the aggregation specified by the configuration file can include various layers of aggregation for different value types.

In some implementations, the process 300 includes determining that the aggregated dataset satisfies a set of validation criteria 350 (as described with reference to FIGS. 1-2). In some implementations, the validation criteria can be specified by a configuration file. In some implementations, the validation criteria can specify that the aggregated dataset must meet a certain minimum or maximum value, or achieve a certain threshold value. In some implementations, the metrics for the validation criteria can be based on external data.

In some implementations, the process 300 includes, in response to determining that the aggregated dataset satisfies the set of validation criteria, providing the aggregated dataset as training data 360 (as described with reference to FIGS. 1-2). In some implementations, the training data can be provided to a machine learning algorithm designed to generate a contextual model for serving digital components. In some implementations, these algorithms can be operating in a model development system co-located with the process 300. In other implementations, algorithms can be operating on external devices over a network.

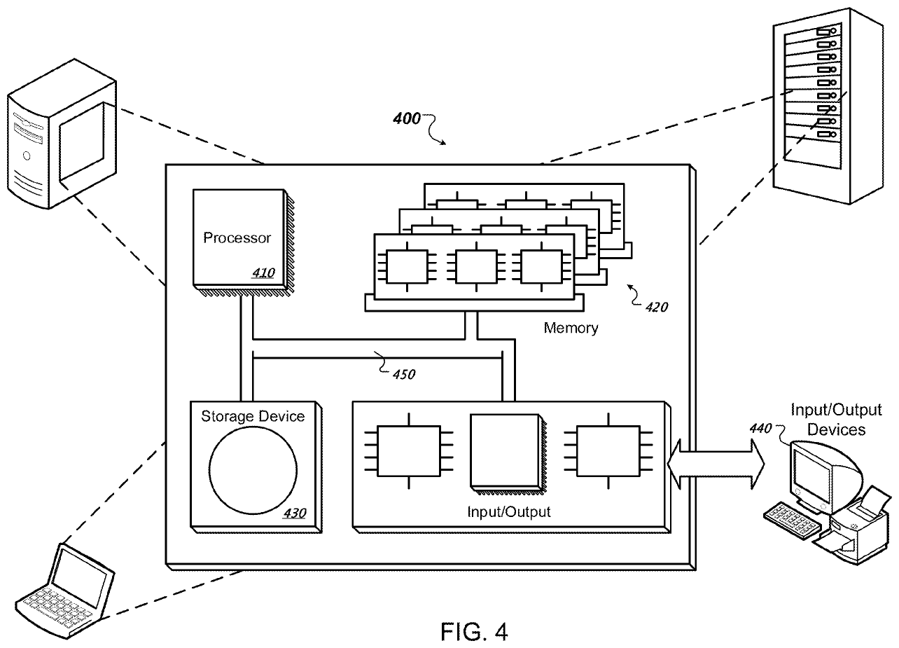

FIG. 4 is block diagram of an example computer system 400 that can be used to perform operations described above. The system 400 includes a processor 410, a memory 420, a storage device 430, and an input/output device 440. Each of the components 410, 420, 430, and 440 can be interconnected, for example, using a system bus 450. The processor 410 is capable of processing instructions for execution within the system 400. In some implementations, the processor 410 is a single-threaded processor. In another implementation, the processor 410 is a multi-threaded processor. The processor 410 is capable of processing instructions stored in the memory 420 or on the storage device 430.

The memory 420 stores information within the system 400. In one implementation, the memory 420 is a computer-readable medium. In some implementations, the memory 420 is a volatile memory unit. In another implementation, the memory 420 is a non-volatile memory unit.

The storage device 430 is capable of providing mass storage for the system 400. In some implementations, the storage device 430 is a computer-readable medium. In various different implementations, the storage device 430 can include, for example, a hard disk device, an optical disk device, a storage device that is shared over a network by multiple computing devices (e.g., a cloud storage device), or some other large capacity storage device.

The input/output device 440 provides input/output operations for the system 400. In some implementations, the input/output device 440 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to peripheral devices, e.g., keyboard, printer and display devices. Other implementations, however, can also be used, such as mobile computing devices, mobile communication devices, set-top box television client devices, etc.

Although an example processing system has been described in FIG. 4, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program which may also be referred to or described as a program, software, a software application, an app, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and pointing device, e.g, a mouse, trackball, or a presence sensitive display or other surface by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone, running a messaging application, and receiving responsive messages from the user in return.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain cases, multitasking and parallel processing may be advantageous.

What is claimed is:

1. A computer-implemented method comprising:
receiving a request for generation of training data using data corresponding to a plurality of client profiles corresponding to a content platform, wherein the training data is for training a contextual model that is used to identify digital components to provide to a client device;
identifying, using a set of configuration files and based on the received request, a key and corresponding value type for extraction from the data corresponding to the plurality of client profiles;
extracting, for each client profile and from the data corresponding to the plurality of client profiles, data for the identified key and corresponding data for the identified value type;
aggregating the data for the identified key and the corresponding data for the identified value type, to obtain an aggregated dataset including the key and an aggregated value type obtained by aggregating the data for the identified value type for the plurality of client profiles;
determining that the aggregated dataset satisfies a set of validation criteria; and
in response to determining that the aggregated dataset satisfies the set of validation criteria, providing the aggregated dataset as the training data to a training pipeline for training the contextual model.

2. The computer-implemented method of claim 1, wherein the aggregating to obtain the aggregated dataset further comprises determining that a data privacy policy is satisfied.

3. The computer-implemented method of claim 2,
wherein the data privacy policy specifies a maximum number of data points for a particular value type corresponding to a particular key; and
wherein determining that the data privacy policy is satisfied comprises determining that the number of the data points for the identified value type satisfies the maximum number of data points.

4. The computer-implemented method of claim 2,
wherein the data privacy policy specifies that the aggregated dataset contains data from a minimum number of client profiles; and
wherein determining that the data privacy policy is satisfied comprises determining that that the aggregated dataset contains more than the minimum number of client profiles.

5. The computer-implemented method of claim 1, wherein determining that the aggregated dataset satisfies the set of validation criteria for training data comprises:
determining, for the identified key, that a distribution of data of the aggregated value satisfies a pre-determined data distribution for the identified value type.

6. The computer-implemented method of claim 1, further comprising:
obtaining additional aggregated data for another value type corresponding to the identified key; and
combining the additional aggregated data for another value type with the training data that is provided to the training pipeline.

7. The computer-implemented method of claim 1, wherein aggregating the data for the identified value type comprises performing a summation, average, or histogram-based operation with respect to the data for the identified value type.

8. A system comprising:
one or more computers and one or more storage devices storing instructions that are operable, when executed by the one or more computers, to cause the one or more computers to perform operations comprising;
receiving a request for generation of training data using data corresponding to a plurality of client profiles corresponding to a content platform, wherein the training data is for training a contextual model that is used to identify digital components to provide to a client device;
identifying, using a set of configuration files and based on the received request, a key and corresponding value type for extraction from the data corresponding to the plurality of client profiles;
extracting, for each client profile and from the data corresponding to the plurality of client profiles, data for the identified key and corresponding data for the identified value type;
aggregating the data for the identified key and the corresponding data for the identified value type, to obtain an aggregated dataset including the key and an aggregated value type obtained by aggregating the data for the identified value type for the plurality of client profiles;
determining that the aggregated dataset satisfies a set of validation criteria; and
in response to determining that the aggregated dataset satisfies the set of validation criteria, providing the aggregated dataset as the training data to a training pipeline for training the contextual model.

9. The system of claim 8, wherein the aggregating to obtain the aggregated dataset further comprises determining that a data privacy policy is satisfied.

10. The system of claim 9,
wherein the data privacy policy specifies a maximum number of data points for a particular value type corresponding to a particular key; and
wherein determining that the data privacy policy is satisfied comprises determining that the number of the data points for the identified value type satisfies the maximum number of data points.

11. The system of claim 9,
wherein the data privacy policy specifies that the aggregated dataset contains data from a minimum number of client profiles; and
wherein determining that the data privacy policy is satisfied comprises determining that that the aggregated dataset contains more than the minimum number of client profiles.

12. The system of claim 8, wherein determining that the aggregated dataset satisfies the set of validation criteria for training data comprises:
determining, for the identified key, that a distribution of data of the aggregated value satisfies a pre-determined data distribution for the identified value type.

13. The system of claim 8, further comprising:
obtaining additional aggregated data for another value type corresponding to the identified key; and
combining the additional aggregated data for another value type with the training data that is provided to the training pipeline.

14. The system of claim 8, wherein aggregating the data for the identified value type comprises performing a summation, average, or histogram-based operation with respect to the data for the identified value type.

15. One or more non-transitory computer storage media encoded with computer program instructions that when executed by one or more computers cause the one or more computers to perform operations comprising:
receiving a request for generation of training data using data corresponding to a plurality of client profiles corresponding to a content platform, wherein the training data is for training a contextual model that is used to identify digital components to provide to a client device;
identifying, using a set of configuration files and based on the received request, a key and corresponding value type for extraction from the data corresponding to the plurality of client profiles;
extracting, for each client profile and from the data corresponding to the plurality of client profiles, data for the identified key and corresponding data for the identified value type;
aggregating the data for the identified key and the corresponding data for the identified value type, to obtain an aggregated dataset including the key and an aggregated value type obtained by aggregating the data for the identified value type for the plurality of client profiles;
determining that the aggregated dataset satisfies a set of validation criteria; and
in response to determining that the aggregated dataset satisfies the set of validation criteria, providing the aggregated dataset as the training data to a training pipeline for training the contextual model.

16. The non-transitory computer storage media of claim 15,
wherein the aggregating to obtain the aggregated dataset further comprises determining that a data privacy policy is satisfied.

17. The non-transitory computer storage media of claim 16,
wherein the data privacy policy specifies a maximum number of data points for a particular value type corresponding to a particular key; and
wherein determining that the data privacy policy is satisfied comprises determining that the number of the data points for the identified value type satisfies the maximum number of data points.

18. The non-transitory computer storage media of claim 16,
wherein the data privacy policy specifies that the aggregated dataset contains data from a minimum number of client profiles; and
wherein determining that the data privacy policy is satisfied comprises determining that that the aggregated dataset contains more than the minimum number of client profiles.

19. The non-transitory computer storage media of claim 8, wherein determining that the aggregated dataset satisfies the set of validation criteria for training data comprises:
determining, for the identified key, that a distribution of data of the aggregated value satisfies a pre-determined data distribution for the identified value type.

20. The non-transitory computer storage media of claim 8, further comprising:
obtaining additional aggregated data for another value type corresponding to the identified key; and
combining the additional aggregated data for another value type with the training data that is provided to the training pipeline.
